(19) United States
(12) Patent Application Publication
(10) Pub. No.: US 2013/0135112 A1
(43) Pub. Date: May 30, 2013

(54) ELECTROSTATIC CONDUCTING DEVICE AND METHOD FOR ELECTROSTATIC DISCHARGE PREVENTION IN ELECTROSTATIC DISCHARGE PROTECTION AREA

(71) Applicants: Shao-Chun Chang, Taoyuan (TW); Ching-Feng Hsieh, Taipei (TW)

(72) Inventors: Shao-Chun Chang, Taoyuan (TW); Ching-Feng Hsieh, Taipei (TW)

(73) Assignees: ASKEY COMPUTER CORPORATION, Taipei (TW); ASKEY TECHNOLOGY (JIANGSU) LTD., Wujiang (CN)

(21) Appl. No.: 13/348,193

(22) Filed: Jan. 11, 2012

(30) Foreign Application Priority Data
Nov. 29, 2011 (TW) 100143667

(51) Int. Cl. G08B 21/00

(52) U.S. Cl. 340/649

(57) ABSTRACT

A method for electrostatic prevention in an electrostatic discharge protection area applicable to an electrostatic conducting device including a main body, an alert unit, a sensing unit and a grounding unit is disclosed. The electrostatic conducting device is used for sensing an external signal and externally coupling to a ground line, and the main body is used for being worn by a user. The sensing unit is coupled to the alert unit for sensing the external signal so as to enable the alert unit. The grounding unit and the alert unit form a loop when being in contact with the skin of the user and coupled to the ground line. The loop is opened when the ground line is coupled to the grounding unit, and the alert unit is thus disabled. Effective ESD protection is achieved.

### FIELD OF THE INVENTION

The present invention relates to electrostatic discharge (ESD) prevention techniques, and, more particularly, to an electrostatic conducting device and a method for ESD protection in an electrostatic discharge protection area with an alert function.

### BACKGROUND OF THE INVENTION

When operating inside an electrostatic discharge protection area (EPA), users (e.g. operators) need to have appropriate protection against electrostatic discharge (ESD) at all time in order to eliminate unwanted generation of static electricity.

In commonly used protective equipment, an antistatic wrist strap is a non-stationary protective tool for discharging static electricity retained in the human body. The wrist strap may comprise a conductive elastic band, a snap, a protection resistor, a plug, a crocodile clip, a press stud etc. In use, the users need to clip the crocodile clip onto an antistatic cord or snap the press stud to an earth bonding point (EBP) and wear the wrist strap around the wrist in close contact with the skin.

However, since the wrist straps are not stationary, users entering and starting to work in the electrostatic discharge protection area may have forgotten to wear the strap. Some users may deliberately not prevent the elastic part of the strap from being close to the skin, because they do not like the restraining sensation imposed by the antistatic wrist strap. This reduces the effect of ESD protection.

Thus, there is a need to effectively remind the users to wear these antistatic wrist straps once inside the electrostatic discharge protection area and wear them close to the skin.

### SUMMARY OF THE INVENTION

In light of the foregoing drawbacks, an objective of the present invention is to provide an electrostatic conducting device and a method for ESD protection in an electrostatic discharge protection area that can effectively prevent ESD and discharge static electricity accumulated on the human body. The present invention provides an electrostatic conducting device that senses an external signal and is electrically coupled to a ground line, comprising: a main body to be worn by a user; an alert unit provided in the main body; a sensing unit provided in the main body and coupled to the alert unit for sensing the external signal and enabling the alert unit; and a grounding unit exposed from the main body forming a loop with the alert unit for contacting the skin of the user and coupling to the ground line, wherein the loop is opened and the alert unit is disabled when the ground line is coupled to the grounding unit.

The present invention further provides a method for ESD prevention in an electrostatic discharge protection area applicable to an electrostatic conducting device including a main body, an alert unit, a sensing unit and a grounding unit, the electrostatic conducting device used for sensing an external signal and externally coupling to a ground line, and the main body used for being worn by a user, the method comprising the following steps of: (1) sending the external signal within the electrostatic discharge protection area; (2) sensing the external signal, by using the sensing unit, to enable the alert unit when the electrostatic conducting device is brought into the electrostatic discharge protection area; and (3) connecting the ground line to the electrostatic conducting device in the electrostatic discharge protection area to disable the alert unit.

Compared to the prior art, the electrostatic conducting device and the method for ESD protection in an electrostatic discharge protection area are capable of reminding users of wearing the electrostatic conducting device inside the electrostatic discharge protection area and wearing it close to the skin and/or coupling it to the ground line to effectively discharge the static electricity to their bodies.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram depicting an electrostatic conducting device according to an embodiment of the present invention;

FIG. 2 is a specific implementation of the electrostatic conducting device according to an embodiment of the present invention; and

FIG. 3 is a flowchart illustrating a method for ESD prevention in an electrostatic discharge protection area according to an embodiment of the present invention.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

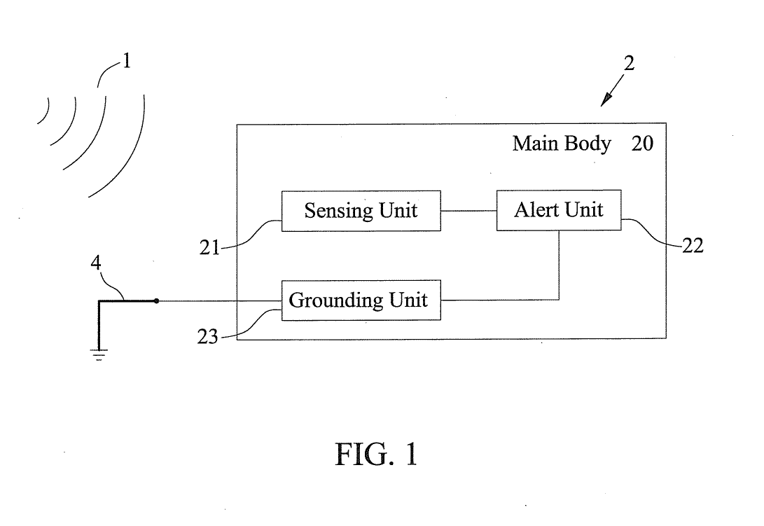

Referring to FIG. 1, a block diagram depicting an electrostatic conducting device according to an embodiment of the present invention is shown. The electrostatic conducting device senses an external signal 1 and is externally connected to a ground line 4.

The external signal 1 may be, for example, a digital electronic wave, analog electronic wave, an infrared signal and the like. The external signal 1 is effect within an electrostatic discharge protection area, which has a radius of about 1˜1.5 meters.

The electrostatic conducting device 2 includes a main body 20, a sensing unit 21, at least one alert unit 22 and a grounding unit 23.

The main body 20 may be worn by a user, for example, worn on the wrist of the user.

The at least one alert unit 22 is provided in the main body 20. The alert unit 22 may be, for example, a warning light, a vibrator, a buzzer or a combination thereof. When a user wearing the electrostatic conducting device 2 enters the electrostatic discharge protection area, the external signal 1 is received by the electrostatic conducting device 2, which enables the alert unit 22 to set off the alarm unit 22. In addition, the sensing unit 21 may be, for example, a signal receiver.

In actual practice, when the electrostatic conducting device 2 has not yet been brought into the electrostatic discharge protection area, the warning light may for example be green, and/or the vibrator and/or the buzzer is inactive; once the electrostatic conducting device 2 is brought into the electrostatic discharge protection area, the sensing unit 21 actuates the alert unit 22 to switch the warning light to red, and/or activate the vibrator and/or buzzer.

The grounding unit 23 is exposed from the main body 20 for providing contact with the user's skin and coupling to the ground line 4. The grounding unit 23 also forms a loop with the alert unit 22. When the grounding unit 23 is connected to the ground line 4, the loop becomes an open circuit and the alert unit 22 is disabled.

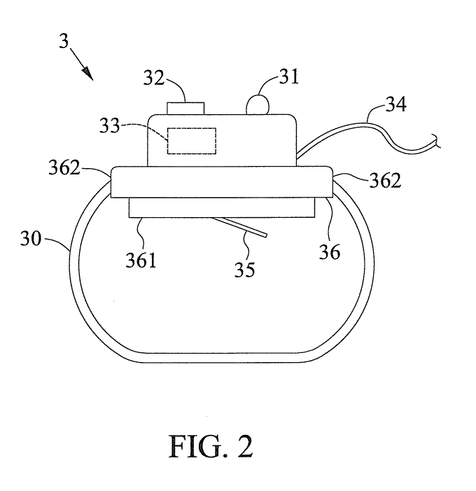

In an embodiment, the main body 20 includes a spring plate 35 (shown in FIG. 2). The spring plate 35 makes contact with the user's skin, so that when the spring plate 35 is pressed, the loop becomes an open circuit and the alert unit 22 is disabled. More particularly, when the user wears the main body 20 tightly against his skin, the spring plate 35 will be pressed, causing the circuit open and disabling the alert unit 22. On the other hand, if the spring plate 35 is not pressed, the loop is not open, and the alert unit 22 is enabled.

In other words, the sensing unit 21 senses the external signal 1 and actuates the alert unit 22 to send an alarm, and when the main body 20 is worn in a way such that the spring plate 35 is pressed, and the grounding unit 23 is coupled to the ground line 4, then that the alert unit 22 is disabled. Thus, when the user enters into the effective range of the external signal 1, a warning is given out by the electrostatic conducting device 2 to remind the user of wearing the main body 20 close to the skin and connecting it to ground, and only when the user has done so, the loop will be open circuited and the alert unit 22 will be disabled.

Furthermore, the main body 20 may further include a battery or charging unit (not shown) for providing current to actuate the alert unit 22. The charging unit and the grounding unit mentioned above may be combined into a transmission line. In addition, the charging unit may for example be a power line.

Referring now to FIG. 2, a specific implementation of the electrostatic conducting device according to an embodiment of the present invention is shown. The electrostatic conducting device 3 includes a main body 36 and a strap 30 extending from both ends 362 of the main body 36 for wearing around the wrist of a user.

Moreover, the electrostatic conducting device 3 includes a warning light 31, a buzzer 32, a vibrator 33 provided within the electrostatic conducting device 3, and a transmission line 34 incorporating a grounding unit and a charging unit. In addition, a spring plate 35 is provided at one side 361 of the electrostatic conducting device 3 that will be in contact with the user. When the electrostatic conducting device 3 is worn around the wrist of the user and the main body 36 is worn tightly against the skin, the spring plate 35 will be pressed, which opens the loop connected to the warning light 31, the buzzer 32 and the vibrator 33.

In actual practice, before the electrostatic conducting device 3 is brought into the electrostatic discharge protection area, the warning light 31, the buzzer 32 and the vibrator 33 are not activated. Once the electrostatic conducting device 3 is brought into the electrostatic discharge protection area, if the electrostatic conducting device 3 is not worn on the wrist or not worn tightly enough around the wrist or the transmission line 34 is not connected to the ground, the warning light 31, the buzzer 32 and/or the vibrator 33 will be activated until the electrostatic conducting device 3 is worn around the wrist close to the skin such that the spring plate 35 is pressed down, and the grounding unit of the transmission line 34 is connected to the ground, opening the loop and disabling the warning light 31, the buzzer 32 and the vibrator 33.

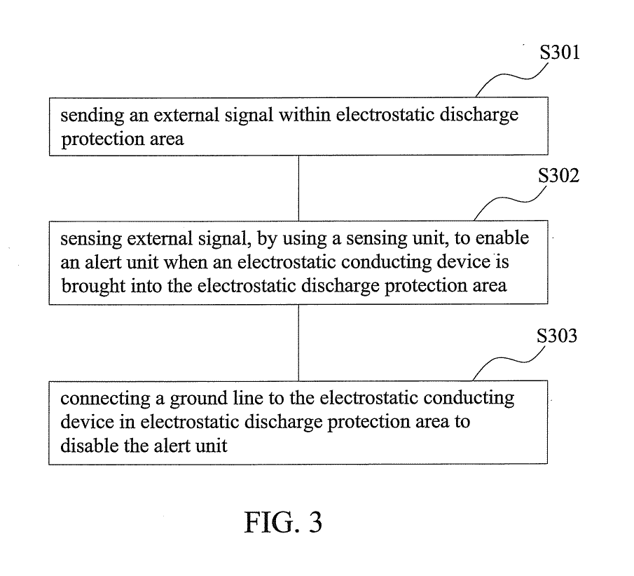

Referring to FIG. 3, a flowchart illustrating a method for electrostatic discharge (ESD) prevention in an electrostatic discharge protection area according to an embodiment of the present invention is shown. The method is applicable to the abovementioned electrostatic conducting device including the main body, the alert unit, the sensing unit and the grounding unit. The electrostatic conducting device is used for sensing an external signal and externally connected to a ground line.

In step S301, the external signal is sent within the electrostatic discharge protection area. In actual practice, a signal transmitter is provided at the center of the electrostatic discharge protection area, and the effective range of the signal transmitter is set to be the range of the electrostatic discharge protection area, which is about 1 to 1.5 meters. Then, proceed to step S302.

In step S302, when the electrostatic conducting device is brought into the electrostatic discharge protection area, the sensing unit senses the external signal and then actuates the alert unit. Then, proceed to step S303.

In step S303, when the ground is connected to the electrostatic conducting device within the electrostatic discharge protection area, the alert unit is disabled. More particularly, the electrostatic conducting device is provided with the sensing unit, the alert unit connected in a loop, a grounding unit and a spring plate. When the user wears the electrostatic conducting device close to the skin, the spring plate is pressed, which opens the loop. As a result, current does not flow to the alert unit, therefore disabling the alert unit. In addition, the alert unit is disabled if the grounding unit is connected to the ground.

Thus, when the electrostatic conducting device is brought into the electrostatic discharge protection area, an alarm will be actuated, and will be disabled only until the user properly wears the electrostatic conducting device on the body (i.e. close to the skin of the user) and the electrostatic conducting device is coupled to the ground line.

In summary, using the electrostatic conducting device provided by the present invention, an external signal can be set to be effect within the electrostatic discharge protection area. When a user enters into the electrostatic discharge protection area, if the electrostatic conducting device is not in close contact with the skin, the alarm in the form of a warning light, a buzzer or a vibrator will be set off to remind the user or report to a manager. The alarm will be disabled only after the electrostatic conducting device is worn on the user in such a way that the spring plate is pressed and the electrostatic conducting device is coupled to the ground line. This serves to effectively remind users to wear the electrostatic conducting device close to the skin inside the electrostatic discharge protection area and connect the electrostatic conducting device to the ground in order to achieve the full effect of ESD protection.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. An electrostatic conducting device that senses an external signal and is electrically coupled to a ground line, comprising:
a main body to be worn by a user;
an alert unit provided in the main body;
a sensing unit provided in the main body and coupled to the alert unit for sensing the external signal and enabling the alert unit; and
a grounding unit exposed from the main body forming a loop with the alert unit for contacting skin of the user and coupling to the ground line, wherein the loop is opened and the alert unit is disabled when the ground line is coupled to the grounding unit.

2. The electrostatic conducting device of claim 1, wherein the main body includes a spring plate for contacting the skin of the user, and the loop is opened and the alert unit is disabled when the spring plate is pressed.

3. The electrostatic conducting device of claim 1, wherein the alert unit includes at least one selected from the group consisting of a warning light, a vibrator and a buzzer.

4. The electrostatic conducting device of claim 1, wherein the main body includes a battery or a charging unit.

5. The electrostatic conducting device of claim 4, wherein the grounding unit and the charging unit are combined into a transmission line.

6. The electrostatic conducting device of claim 1, wherein the main body includes a strap extending from both ends of the main body for wrapping around a wrist of the user.

7. The electrostatic conducting device of claim 1, wherein the external signal is effective within an electrostatic discharge protection area.

8. The electrostatic conducting device of claim 7, wherein the electrostatic discharge protection area has a radius of 1 to 1.5 meters.

9. A method for ESD prevention in an electrostatic discharge protection area applicable to an electrostatic conducting device including a main body, an alert unit, a sensing unit and a grounding unit, the electrostatic conducting device used for sensing an external signal and externally coupling to a ground line, and the main body used for being worn by a user, the method comprising the following steps of:
(1) sending the external signal within the electrostatic discharge protection area;
(2) sensing the external signal, by using the sensing unit, to enable the alert unit when the electrostatic conducting device is brought into the electrostatic discharge protection area; and
(3) connecting the ground line to the electrostatic conducting device in the electrostatic discharge protection area to disable the alert unit.

10. The method of claim 9, wherein the external signal is effective within the electrostatic discharge protection area.

11. The method of claim 9, wherein the electrostatic discharge protection area has a radius of 1 to 1.5 meters.
